(19) United States
(12) Patent Application Publication
(10) Pub. No.: US 2011/0130297 A1
(43) Pub. Date: Jun. 2, 2011

(54) QUANTUM DOT-SENSORY ARRAY FOR BIOLOGICAL RECOGNITION

(75) Inventors: Christopher S. Badorrek, Hagerstown, MD (US); Don B. Elrod, Silver Spring, MD (US); Michael J. Bowers, Eldersburg, MD (US); Myeongseob Kim, Ellicott City, MD (US); Terence L. Schull, Alexandria, VA (US)

(73) Assignee: BAE Systems Information and Electronic Systems Integration Inc., Nashua, NH (US)

(21) Appl. No.: 12/933,972

(22) PCT Filed: Jan. 22, 2010
(86) PCT No.: PCT/US10/21813

§ 371 Date: Sep. 29, 2010

Related U.S. Application Data
(60) Provisional application No. 61/147,027, filed on Jan. 23, 2009.

(51) Int. Cl. C40B 30/00; C40B 40/04; C40B 60/12

(52) U.S. Cl. 506/7; 506/15; 506/39

(57) ABSTRACT

The present invention provides a quantum dot-based biomolecule sensor array capable of differentiating the strain of a variety of biological molecules including bacteria, spores, fungi, viruses, and disease-causing prions. The biosensor uses specific chemical functionalities that regulate the interactions between different chemical ligands and biological molecules.

### BACKGROUND OF THE INVENTION

A. Field of the Invention

The invention relates generally to a biomolecule sensor array capable of broad-based biosensing of any biomolecule. More particularly it relates to a biomolecule sensor array using quantum dots for differentiating a variety of biological and weaponization molecules.

B. Description of the Related Art

The number of individuals stricken with nosocomial (hospital-acquired) infections in the US each year is alarming. Two million people acquire nosocomial (hospital-acquired) infections in the United States each year, at an infection rate of 5 cases per 100 admissions. The annual cost of these infections totals $4.5 billion and they result in approximately 88,000 deaths. Of these infections, 70% are caused by microorganisms resistant to at least one antimicrobial agent (Altman, 1998). Given the number of reported deaths and total healthcare cost incurred, this has become a serious health issue in the US and around the world.

Currently, no rapid methodology exists that can differentiate drug resistant agents from non-drug resistant agents as in the case of differentiating methicillin-resistant Staphylococcus aureus (MRSA) from methicillin-susceptible Staphylococcus aureus (MSSA) (Riberio, 1999). Further, some point-of-care technologies have been plagued by false positives for resistant strains. The result can be that the wrong therapy is administered, such as administering a powerful, broad-spectrum antibiotic agent when a simple beta-lactam would have been sufficient. Patients may also undergo unneeded isolation and barrier protection regimens if wrongly diagnosed with MRSA.

Due to the fact that most of the infections are caused by microorganisms resistant to at least one therapeutic agent, the timely and proper identification of the causative pathogenic microorganism is of paramount importance. The accuracy level needed of sensor devices for the rapid differentiation of resistant and non-resistant forms of the same microorganism has still not been achieved. Currently, the most accurate methods rely on conventional plating and culturing techniques which are time-consuming and require at least 24 hours for results, thereby delaying treatment. What is urgently needed is a point-of-care diagnostic device which can quickly determine the pathogen responsible for illness (bacterium, virus, fungus, etc.), its particular strain, and if it is antibiotic-resistant or not.

Current research in developing rapid, biosensor devices has often relied on the specific binding of the analyte of interest with the bioreceptor element of the device. Of those current technologies that are array-based and touted as “non-specific,” most are constructed with a certain analyte or analyte class in mind. Current biomolecule sensing technologies can be classified based upon (i) specific interactions between the biosensor's receptor (antibody, enzyme, aptamer) and the specific analyte of interest or (ii) more broad-based, non-specific interactions from an array of more simplistic, diverse molecules (peptides, double- or single-stranded nucleic acid oligomers, organic small molecules) that results in a selective pattern that is deconvoluted and assigned to the detected analytes. While specific sensors are very selective for the agent of interest for which they are designed, they have limited selectivity for any other agent. Thus, with this approach, constructing recognition components for every potential biomolecule of clinical importance is required, and this is impractical and time consuming.

For the last two decades, there have been many great advances in the field of biosensor development for applications in the general medical field and for industries such as food and beverage manufacturing. Biosensors are generally classified by their receptor or transducer type (Vo-Dinh and Cullum, 2000). Among the types of bioreceptors are: 1) antibody/antigen, 2) enzymes, 3) cells, 4) nucleic acids, and 5) biomimetic materials. Transducers utilized in biosensor design include: 1) optics (luminescence, absorption, surface plasmon resonance, etc.), 2) electrochemical, and 3) mass-sensitive measurements (e.g., surface acoustic wave, microbalance, etc.).

Several researchers have used various biological interactions for the receptor portion of their biosensor design. Vo-Dinh et al. have described a biochip design incorporating nucleic acid and antibody probe receptors specific to gene fragments of Bacillus anthracis and Escherichia coli, respectively (Vo Dinh, 2003). Heller and coworkers have developed an electrochemical immunoassay for whole blood (Campbell, 1993), which uses a redox hydrogel on a carbon electrode containing co-immobilized avidin and choline oxidase. Biotinylated antibody is then bound to the gel, and upon exposure to the antigenic analyte and another complementary horseradish peroxidase-labeled antibody, the hydrogel reduces hydrogen peroxide to water. Enzymatic-based biosensors have been developed by Gauglitz and coworkers in which enzymes were immobilized onto an array of optical fibers to detect penicillin and ampicillin simultaneously (Polster, 1995). Penicillinase is employed to hydrolyze the two analytes causing a change in pH (indicated by phenol red). Shifts in the reflectance spectrum were measured in order to obtain their respective concentrations indirectly.

Other scientists have utilized nucleic acid hybridization to construct “genosensors.” Specificity comes from complementary base pairing of RNA or DNA. If the DNA sequence of a biological analyte is known, the complimentary sequence is used as a probe and labeled with a fluorescent tag. Unwinding the DNA of the analyte of interest, exposing it to the probe, and annealing the strands will promote hybridization between the probe and its complementary strand on the analyte. Grabely and coworkers have constructed sensors based on the binding of DNA-ligand binding events (Piehler, 1997). Surface plasmon resonance was used to monitor real-time binding of low molecular weight ligands to DNA fragments bound to the surface of the sensor. Karube and coworkers have demonstrated a biosensor that uses a peptide nucleic acid as the bioreceptor (Sawata, 1999). The synthetic peptide-nucleic acid conjugate binds strongly to complementary oligonucleotide sequences. Direct detection of DNA could be achieved using surface plasmon resonance techniques in the picomolar concentration range. Although these technologies have been shown to be specific and sensitive for certain biomolecules, they unfortunately cannot be extended to other biomolecules of interest without substantial reconstruction efforts.

Differential array sensors involving electrochemical, microelectrode, fiber optic, surface acoustic array, conducting polymer, and metal oxide field effect transistor technologies have been employed for detection of various analytes (Epstein and Walt, 2003; Toko, 1998a; Toko, 1998b; Walt, 1998; Laukis, 1998), in addition to array-type sensors employing synthetic receptors for use in the detection of biological molecules. Several groups have focused on array-type sensors using synthetic receptors to detect biological molecules. Ansyln and coworkers have utilized combinatorial chemistry to attach variable peptide arms in an array-type device to differentiate nucleotide phosphates (McCleskey, 2003), proteins, glycoproteins (Wright, 2000a) and tripeptides (Wright, 2000b). Hamilton et al. have also developed sensor arrays for pattern-based recognition of proteins and glycoproteins (Baldini, 2004) employing an array of porphyrins with modified amino acids. The inherent fluorescence of the porphyrin receptors serves as the indicating signal. Kodadek and coworkers has demonstrated the use of small molecule microarrays to create fingerprint patterns of proteins (Reddy, 2005). A series of 7680 octameric peptoids with terminal cysteine functional groups were synthetically attached to a maleimide functionalized microscope slide. A series of fluorescently labeled proteins were measured in separate experiments and their respective patterns generated. McCauley and coworkers have developed a chip-based biosensor utilizing immobilized fluorescently-labeled DNA and RNA aptamers selected against various protein targets to detect protein levels in biological mixtures for cancer diagnosis (McCauley, 2003). Rowe and coworkers have developed a biosensor utilizing a standard sandwich immunoassay format. Antigen-specific antibodies were immobilized into a patterned array on the surface of a planar waveguide to detect Bacillus globigii, MS2 bacteriophage, and staphylococcal enterotoxin B upon addition of secondary fluorescent tracer antibodies (Rowe, 1999).

However, many of these array-like technologies were developed with a certain class of molecules in mind and are invasive, meaning that they require denaturing or breaking open the cell to expose cellular components, and thus require additional steps for proper analysis. Furthermore, many of the more broad-based approaches still use complex receptors that contain many different types of chemical characteristics and thus do not have the means to rapidly understand which of those chemical characteristics within their array is really doing the recognition of the analyte.

Thus, while researchers have begun studying more broad-based array-like approaches, many of these array-like systems are still created with a certain class of molecules in mind and due to the complex nature of the receptors used (for example, nucleic acid oligomers have various chemical functionalities associated with their 4 nucleobases, the ribose ring, and the negatively-charged phosphate backbone, all of which can potentially interact with agent of interest), the specifics of the interactions between receptor and analyte are not always fully understood. In addition, the target analyte of many biosensors mentioned are located intracellular and require invasive means, e.g., cell denaturation/degradation, to obtain analyte. Further, many biosensor designs suffer from the optical transduction element, specifically fluorescent organic compounds, which have many associated drawbacks. A device that can accept any biological analyte has yet to be achieved.

There is a dire need for novel low cost, rapid, robust, and broad-spectrum approaches for early detection and identification of biological agents in clinical and environmental samples, potentially to include recognition of emerging threat agents that are natural, e.g., new strains as in H1N1 influenza, or artificial, e.g., weaponization. The present invention is directed to overcoming or at least reducing the effects of one or more of the problems set forth above, and in providing a way of easily, rapidly and accurately identifying biological agents in clinical and environmental samples.

### SUMMARY OF THE INVENTION

The present invention provides a novel biosensor design in which the receptor component (i) is not originally designed with any biological agent in mind, (ii) is chemically simplistic such that its composite response can be rapidly understood and readily modified as necessary, (iii) will probe the surface chemical characteristics of the biomolecule, so that denaturation/degradation is not required, and (iv) is coupled with a robust, highly sensitive transduction element, in this case, a quantum dot. Since every biomolecule has a unique surface structure containing various chemical characteristics, each biomolecule will interact with simple chemical ligands in a specific pattern. The novel and adaptable biosensor enables rapid differentiation and identification of a multitude of pathogenic, non-pathogenic, resistant, and susceptible microorganisms using a single device, thereby to ensure rapid and appropriate treatment.

The present invention provides a quantum dot-based biomolecule sensor array capable of differentiating a variety of biological molecules within the same sample, including bacteria, spores, fungi, viruses, and disease-causing prions. Furthermore, it can be combined with algorithm designs based on singular value decomposition (SVD), which can be used to locate small signals hidden within an overall complex signal (Doxas, 2007). That is, small patterns of signals from the quantum dot sensory array that comprise a bioagent “fingerprint” can be used to rapidly identify an agent in a complex environment. The biosensor according to the invention relies upon the specific chemical functionalities that regulate the interactions between different chemical ligands and biological molecules. The present array-based approach to biosensor development was selected because of the above-mentioned practicality issues involved in developing a separate recognition component for every biomolecule of interest.

The biosensor according to the invention includes both a receptor and a transducer. The present invention utilizes an array of quantum dots to which are bound different ligands. The ligands are tethered at one end to the quantum dot and have a functional group at the other end. The quantum dots are the indicator. The quencher interacts with the functional group on the chemical ligands that are bound to the quantum dot, resulting in a quenched, or “turned off,” quantum dot. When the array contacts a sample, biomolecules (for example, proteins) in the sample displace the quencher from the functional group on the ligand, and the quantum dot signal is “turned on” and can be measured. More particularly, the biosensor comprises a receptor array and quantum dot transducers where the analytical technique of Förster resonance energy transfer (FRET) is used to monitor the interaction between the receptors and the biomolecules.

For clinical purposes, the biosensor according to the invention can accurately identify the origin of infection, which allows medical personnel to quickly diagnose and provide the proper therapeutic regimen.

By using relatively simple ligands, the biosensor according to the invention also can be used to study the basic chemical interactions between receptors and the ligands, to enhance biosensor capabilities. Moreover, the knowledge gained can be applied to many fields of science beyond sensors, such as pharmaceutical science and molecular biology.

The present invention provides a new approach to biosensor design in which the receptor component (i) is not originally designed with any biological agent in mind, (ii) is chemically simplistic such that its composite response can be rapidly understood, (iii) will probe the surface chemical characteristics of the biomolecule so that denaturation/degradation is not required, and (iv) is coupled with a robust, highly sensitive transduction element. Since every biomolecule has a unique surface structure containing various chemical characteristics, each biomolecule will interact with simple chemical ligands in a specific pattern. The present approach provides an adaptable sensor which can be used to rapidly differentiate and identify a multitude of pathogenic, non-pathogenic, resistant, and susceptible microorganisms, to ensure rapid and appropriate treatment.

### BRIEF DESCRIPTION OF THE DRAWINGS

The foregoing advantages and features of the invention will become apparent upon reference to the following detailed description and the accompanying drawings, of which:

FIG. 1 shows the technique according to the invention with simple chemical ligands which differ only in the functional R chemical group that is attached at a positively-charged quaternary ammonium moiety.

FIG. 2 demonstrates general technology used to implement the present invention.

FIG. 3 shows a reaction scheme for coupling of ligands to quantum dogs according to the invention.

FIG. 4 shows quaternary amine ligands (left panel) and chosen quencher (right panel).

FIG. 5 shows induced quenching of quantum dot in presence of AuNP—SO₃ as the negatively charged SO₃ interacts with positively charged quaternary ammonium group (compare to AuNP OCH₃ where residual quenching occurred).

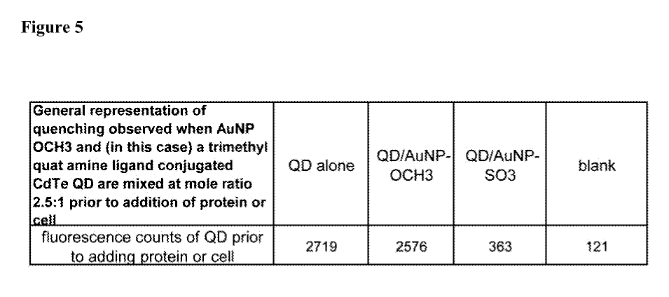

FIGS. 6A and 6B show QD fluorescence recovery data collected from quaternary amine ligand conjugated commercial (Invitrogen) and CdTe core QDs that were interacted with AuNP—SO₃ quencher and then exposed to various proteins and cells of interest. FIG. 6C shows QD fluorescence recovery of CdSe/ZnS QDs (that varied only by % of carboxylic sites for quaternary amine ligand attachment) after interaction with AuNP—SO₃ quencher and then exposed to two proteins alone and when mixed

### DETAILED DESCRIPTION OF SPECIFIC EMBODIMENTS

The Quantum Dot-Sensory Array for Biological Recognition (QSABR) system is a sensor array that can contain multiple chemical ligands conjugated to stable (resistant to photobleaching) quantum dots that are capable of differentiating between various types of biomolecules, including strains of the same pathogen. Unlike many previous sensors which rely on complex molecules like antibodies, nucleic acids, or small molecules, QSABR monitors the interaction between the surface of a biological molecule of interest with an array of various simple chemical ligands tethered to stable quantum dots that only vary at one R position by using Förster resonance energy transfer (FRET). The pattern of recognition can then be categorized into a library and assigned to that agent of interest as a “fingerprint.” Moreover, the surface chemical characteristics of the biomolecule also are interrogated since the user can observe which R groups in the chemical ligand array interacted with the biomolecule. Further, QSABR combined with SVD analysis (Doxas, 2007) can allow for monitoring of ANY bioagent of interest (based upon what has been catalogued) that is in a complex mixture.

The broad-based biosensing array can be used to sense any biomolecule, including, but not limited to, fungus, mammalian/bacteria cell, virus, protein, by using a robust, chemical ligand sensory array that is coupled to a highly sensitive signal transduction quantum dot. Further, this system has the capability of differentiating between the same strain of a variety of bioorganisms as previously demonstrated with gold nanoparticles (Phillips, 2008), but in combination with more stable QD capability.

The broad-based biosensor according to the present invention extends the ability of a biosensor to differentiate a multitude of biological analytes, including proteins, bacteria, spores, and viruses, to name just a few. The novel array-based biosensor can be constructed without predetermination of what the analyte of interest is. It thus provides an adaptable sensor platform, rather than an analyte- or class-specific device.

The present invention provides an adaptable sensor capable of differentiating biological materials no matter their identity, and satisfies an urgent need in the areas of defense, medicine, food, and environmental safety. The technology benefits healthcare by providing rapid and accurate diagnosis of the cause of an infection so that the proper therapeutic regimen can be given. This provides for patient safety as well as reduced recovery time, which will positively impact the cost of their hospitalization. The technology benefits defense initiatives as the overall concept is rapid and robust, and is suited to use in field-deployable devices.

A first step according to the invention is to conjugate a library of chemical ligands to water-soluble quantum dots. This allows the synthesis and characterization of the quantum dot-ligand conjugate system in preparation for FRET optimization in a subsequent step. Water soluble quantum dots can be prepared by methods described in the literature. Chemical ligands of a specific hydrocarbon chain length that contain a functional group on the end of the molecule can be covalently attached to the quantum dot. The hydrocarbon chain can include both hydrophilic and hydrophobic portions, for example straight carbon chains and polyether portions. The functional group on the end of the molecule can be either a positively charged group, such a quaternary ammonium group (as exemplified in the examples), or a negatively charged group, such as a phosphate, borate, or sulfate functional group or certain polymers. The functional group can be generated using known chemistries, and can vary with respect to size, shape, hydrophobicity, and hydrophilicity

Specifically, in the case of the quaternary ammonium group, the difference between ligands is in the specific groups directly attached to the nitrogen of the positively charged quaternary ammonium moiety. The average number of ligands per quantum dot can be estimated by employing Rutherford backscattering spectroscopy or qualitative extraction using conventional fluorescamine chemistry on the remaining ligands not conjugated to the quantum dot. The “quenching” molecule in the case of a positively-charged functional group on the ligand on the quantum dot is negatively-charged. It can be either obtained commercially or generated in the laboratory using simple and known place exchange chemistry methods.

In a second step, FRET is optimized and binding affinity of the quencher to the quantum dot-ligand conjugates is determined. This allows determination of the extent of binding between the chemical ligands and the “quenching” molecules, and the binding needed between quencher and the ligands attached to the quantum dots can be optimized in order to produce varying amounts of measurable fluorescence signals when exposed to biological analytes. Various quantum dot-ligand conjugates can be tested to determine the optimum set of quantum dot-ligand conjugates. The optimized set then can be used to construct an array.

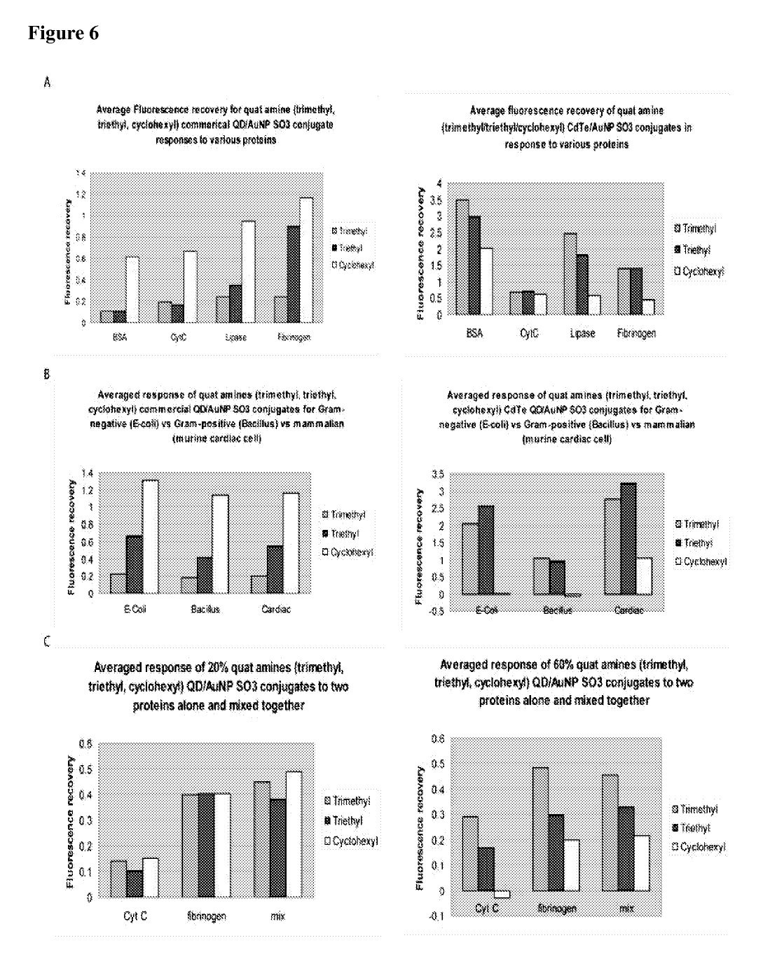

Finally, once an array is constructed, reproducible fluorescence patterns from the interactions of the solution-based biosensor components can be demonstrated as shown with various proteins, and Gram (+)/Gram (−)/mammalian cell suspensions. See FIG. 6. The ability of each array to produce unique patterns for various biological molecules can be tested. As shown in FIG. 6, using a 96-well microplate, a series of quantum dot-ligand conjugate solutions, each containing a different ligand, that have been precisely quenched with quencher are exposed to set concentrations of proteins and a Gram (−)/Gram (+) bacteria, and mammalian cell line in separate experiments for a predetermined amount of time.

The present invention combines a simple chemical receptor array element capable of producing a unique pattern for a particular biomolecule, with the sensitive, robust fluorescent signaling of quantum dots and FRET sensing. The degree of functionalization of the quantum dot can be determined for a unique chemical ligand. Furthermore, the stoichiometric ratio and binding affinity of each ligand-bound quantum dot to dark quencher can be determined in order to optimize the array. Finally, the creation of reproducible unique patterns for each biomolecule can be catalogued into a library of “fingerprints” which can be used for rapid identification of biological molecules in laboratory and, in the long term, environmental settings.

The present invention allows increased understanding of the physical interactions between the biomolecule analyte and receptor components of an array-based system. It also produces a positive impact on defense and healthcare by providing medical personnel and first responders with a rapid and accurate diagnostic tool.

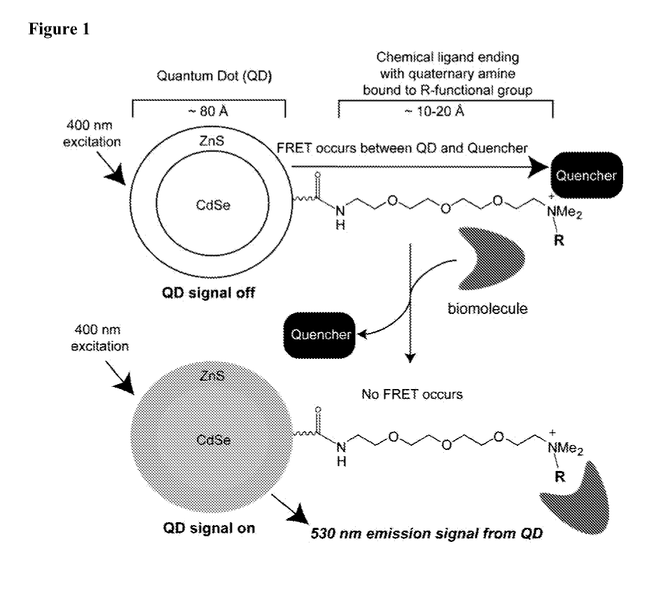

The biosensor is exemplified herein with quantum dots conjugated with simple chemical ligands which differ only with respect to the substituents on a quaternary ammonium group. These simple chemical ligands differ only by the functional R chemical group (which will differ in hydrophobicity, electrostatics, etc) that is attached at a positively-charged quaternary ammonium moiety, as shown in FIG. 1. Since only the R functional group differs between ligands, the chemistry associated with how that particular R group responds to the surface of a biological molecule of interest can be assessed. By creating an array of various ligands, chemical “characteristics” exposed on the surface of a biomolecule can systematically be studied. These can be observed on the array as a unique pattern that can be catalogued as a “fingerprint” for the biomolecule of interest.

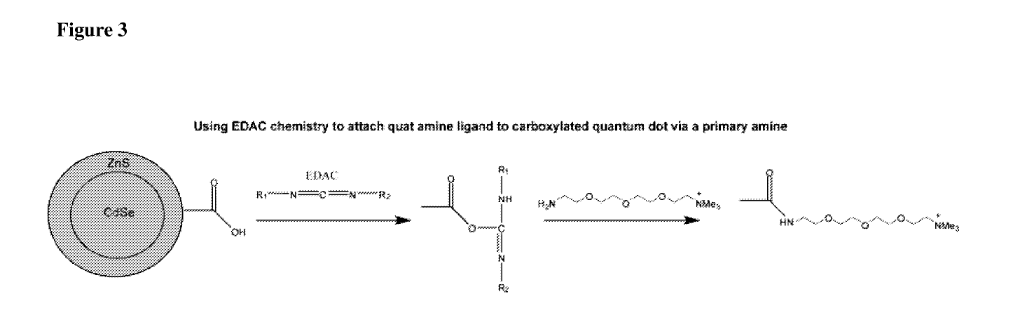

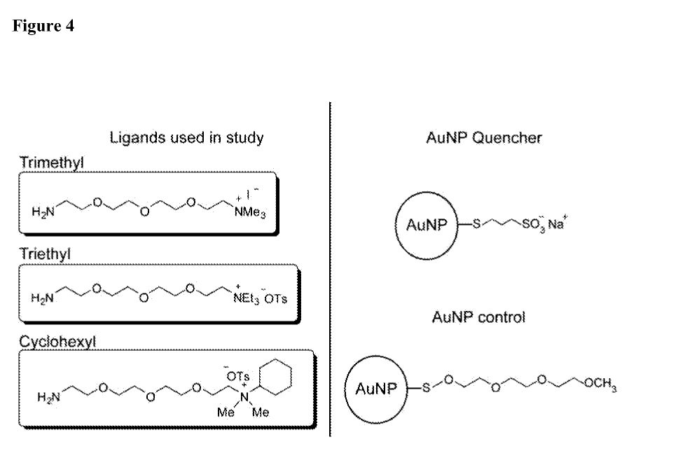

In order to observe the pattern produced, a photostable signal transduction scheme is required (FIG. 1). This is accomplished by attaching (FIG. 3) photobleaching-resistant, high quantum yield water-soluble quantum dots to one end of the chemical ligand (FIG. 4, left panel), while the negatively-charged quencher (FIG. 4, right panel) will interact with the positively-charged quaternary ammonium moiety. The quencher here has broad absorption spectra which overlay with the emission of the quantum dot, so that FRET occurs between the dot and the quencher. Upon exposure to the biomolecule of interest, the quencher is displaced as the chemical ligands interact with the biomolecule. See FIG. 1. This leads to a visible signal from the quantum dot. Through this approach, the surface characteristics of the biomolecule can quickly be assessed by observing which of the chemical ligands in the array are interacting. As an added advantage, the surface of all biomolecules are unique and thus specific patterns of recognition (“fingerprints”) in the array are produced. Reaction of different types of bacteria with various simple chemical ligand arrays against proteins that vary in size and charge (pI) have been found to produce unique patterns of recognition for each of the biomolecules tested, as described herein. However, the biosensor can be used to differentiate and identify more complex ligands. The binding of biomolecules to the simple chemical ligand receptors exemplified herein demonstrate what is required for a reasonable competition between the quencher and the biological analyte for interaction with the ligands in order to obtain detectable signal patterns, and thus defines the basic requirements for a broad-based biosensor array. The number of ligands required to produce a selective and reproducible pattern for identifying proteins, bacteria, spores, and viruses can be determined in accordance with the protocols set forth herein. Further, this system is designed to be amenable to current front end extraction methods and back end pattern recognition algorithms which assist in removal of “background” noise of the array and analysis of the signal generated by array, respectively. In this regard, samples may be treated prior to their contact with the array, to remove contaminating proteins.

Förster resonance energy transfer (FRET) is the nonradiative long range transfer (10-100 Å) dipole-dipole coupling of excitation energy from an excited fluorophore donor to a proximal ground-state fluorophore acceptor (Förster, 1946). The main advantage is the dependence (1/d⁶) of the energy transfer and hence the sensitivity. Because of this sensitivity to donor-acceptor distance, FRET has proved to be useful for detecting interactions at the molecular scale such as binding events and changes in conformation of proteins. Quantum dot based assemblies with proteins or peptides using FRET have been constructed to specifically detect target molecules including soluble TNT and the activity of various proteolytic enzymes (Medintz, 2003; Goldman, 2005; Medintz, 2006). Among the strategies for analyte-mediated distance changes are: 1) the analyte competes with the fluorescent ligand for binding to the receptor (Medintz, 2003; Goldman, 2005), 2) the analyte specifically cleaves the linkage between the quantum dot donor and acceptor (Gill, 2005; Medintz, 2006), and 3) the analyte changes the conformation of the linkage between the donor and acceptor (Medintz, 2005).

There are several reasons why quantum dots are typically of interest as FRET donors (Fernandez-Arguelles, 2007) including: 1) reduced spectral cross-talk between donor and acceptor signals, 2) the size-tunable donor emission for optimal spectral overlap with the acceptor absorption, and 3) the narrow symmetric donor spectrum eliminates the common problem of the donor red tailing into acceptor emission wavelengths. In addition to the benefits of using quantum dots for FRET, the following paragraphs describe the properties of quantum dots and the advantages of employing them in place of the classical fluorophores.

The quantum dots used according to the invention are colloidal semiconductor nanocrystals with three dimensions on the nanometer (˜1-100 nm) scale. While physically identical to their larger parent materials, the electronic and optical properties are size tunable as a result of quantum confinement (Murray, 2000; Nirmal, 1999). The popularity of these materials as potential solutions for many opto-electronic and imaging applications stems from the ability to tune the electronic structure (e.g. band gap) of the material simply through size (via growth time) or composition (via change of precursor) making it possible to produce many electronically different materials from the same synthetic platform (Murray 2000, Nirmal 1999). The most widely studied of the II-IV quantum dot materials in terms of synthetic maturity, physical and opto-electronic characterization is cadmium selenide (CdSe). The band gap of CdSe is fully tunable through the visible spectrum by simply changing the size of the quantum dot. The opto-electronic properties of quantum dots can be further modified by adding epitaxial layers of other semiconductor materials to the surface. Traditionally, quantum dots have been wrapped in an epitaxial shell to provide complete surface passivation as well as electronic confinement of the photogenerated charges. This is necessary for applications requiring highly fluorescent materials.

CdSe typically exhibits either the wurzite or sphalerite (cubic) crystal structures with alternating layers of cadmium and selenium atoms along the c-axis. This alternating stacking pattern leads to [001] and [001]′ facets on the nanocrystals being cadmium and selenium terminated, respectively, resulting in a polar lattice and a large intrinsic dipole.ⁱ It is this large intrinsic dipole that facilitates the separation of charge in quantum dots which allow them to be useful in devices such as photovoltaics and in FRET detection schemes.

The unique photophysical properties inherent to quantum dots provide numerous advantages over conventional organic dyes in several fluorescent imaging applications. Specifically, quantum dots have been engineered to have a narrow, size-tunable fluorescent emission which is extremely bright and photostable. These emission properties are characteristically different from organic fluorophores, which generally have broad, log-normal fluorescent spectra subject to rapid photobleaching. As a result of their narrow, photostable fluorescence, quantum dots have been utilized as improved probes for multiplexed, dynamic imaging applications, both in vitro and in vivo. Additionally, their improved brightness even facilitates receptor trafficking experiments with enhanced sensitivities at the single molecule level (Warnement, 2007).

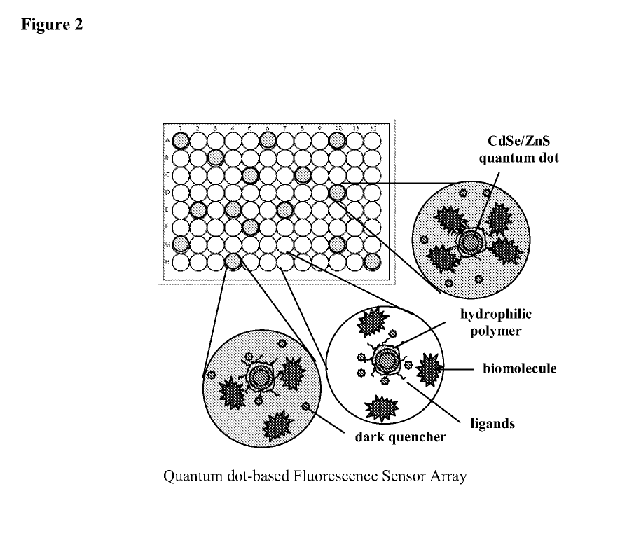

The general technology used to implement the present invention is shown in FIG. 2, and is a much more inclusive approach as to the variety of analytes that could be detected by a single array as compared with current research systems. The work is based, not on specific interactions between a biomolecule of interest and the bioreceptor component of the sensor, but on a pattern of interactions on an array that more closely resembles the semi-selective mammalian sensory elements of smell and taste where the combination of interactions of aromas tastebuds or olfactory receptors produce a pattern that is processed and stored in the brain as the “fingerprint” of the specific smell or taste.

Previous “chemical ligand based fingerprinting” work has been demonstrated using a plate reader system. The device which has been employed contains, in each well: 1) gold particles coupled to six different chemical ligands possessing pendant quaternary ammonium groups (quat) that are positively-charged, and 2) a fluorescent indicator in the form of a carboxylated poly(p-phenylene ethynylene) polymer (You, et al., 2007). This particular chemical ligand induced system works by the fluorescence quenching of the fluorescent indicator by interaction of the negatively-charged carboxylate groups with the positively-charged quaternary groups of the various chemical ligands (different only in the alkyl groups on the quaternary moiety) which places the polymer at a distance to the gold particle wherein its fluorescence is quenched (or turned off). Exposure to a biomolecule of interest (protein, microbe, virus, etc.) and subsequent interactions of various functionalities on the biomolecule with the chemical ligands results in a percentage of the fluorescent polymer being displaced away from the vicinity of the quenching gold particle such that it begins to give a fluorescent signal (turned on). The more polymer units that are displaced the greater the fluorescent signal.

When six separate gold/ligand/polymer systems are exposed to a single biomolecule, each well in the microplate fluoresces at a different intensity due to different degrees of polymer displacement. This produces a “lighted” pattern for each biomolecule analyte. This technique was used to generate pattern “fingerprints” for several different protein analytes. After exposing seven different protein analytes (six replicates) to the same array in separate experiments, the fluorescent patterns were analyzed by linear discriminant analysis (LDA), a statistical method used in pattern recognition (Brereton, R. G., 2003 and Jurs, P. C., 2000) to assign a pattern to each protein analyte, as shown in FIG. 2. The patterns were observed to be highly repeatable for a given protein. The method was then used to identify 52 unknown protein samples (seven different proteins) with an accuracy of 94.2%.

The utility of this biosensor to differentiate bacterial analytes also has been demonstrated. Using a 3-chemical ligand array system, 12 different bacteria were differentiated. In addition, out of 64 unknown samples (12 different bacteria) 61 were correctly identified giving a detection accuracy of >95%. Moreover, 3 different strains of Escherichia coli could be differentiated. The subtle differences in these strains generated markedly different changes in response. This data shows that this technology has the ability to differentiate different strains of the same pathogen, which would be instrumental in applications such as discerning MRSA from MSSA in clinical settings. Further optimization of the present technology is accomplished by incorporating a more sensitive, robust transduction element that can be further tethered to a surface.

However, there are certain limitations with the gold nanoparticle system. Most, if not all, of the limitations are overcome by the QSABR approach. Unlike fluorescent molecules, which have inherent stability issues with photobleaching, quantum dots are very photostable and have the added advantage of narrow, easily tunable emission widths to facilitate facile multiplexing which is advantageous for future long term goals, i.e., complex mixture deconvolution. Also, quantum dots can easily be tethered to a myriad of surfaces. This is instrumental in increasing signal to noise, i.e., by condensing the signal to one area, and device design. Further, as designed, QSABR results can be combined with SVD analysis for sample signal deconvolution.

In accordance with the present invention, certain changes are implemented with respect to the technology just described. These include the following: 1) the gold nanoparticle absorbers are replaced with quantum dots which emit in the visible range and are covalently linked to the chemical ligands, and 2) the fluorescent polymer indicators are replaced with charged quenching moieties. Quenchers can consist of gold nanoparticles or small molecule-like dyes, such as black hole quenchers (BHQ®) from Biosearch Technologies. These quenchers have no inherent fluorescence, but can be used to quench other fluorescent molecules, or in this case quantum dots, due to their broad absorption spectrum. Hence the location and identities of the absorber (small molecule-like dyes or gold nanoparticles) and fluorescent indicator (stable, non-photobleaching quantum dots) is reversed. According to the present invention, the chemical ligands are bound to the indicator (quantum dots) instead of to the absorbing quencher. The quencher (negatively-charged, FIG. 4) interacts with the positively-charged quaternary ammonium group on the chemical ligands that are bound to the quantum dot, resulting in a quenched, or “turned off,” quantum dot. The starting material for the quencher employed is commercially available (and require minimal one step place exchange chemistry) to obtain the AuNP—SO₃ and the quantum dots and chemical ligands are readily made by one of skill in the art.

According to the invention, an array of quantum dots with different ligands (each well has only one type of chemical ligand bound to the quantum dots rather than many various types of ligands) are exposed to one type of biomolecule. The biomolecule surfaces having negatively-charged portions as well as hydrophobic and hydrophilic groups, interact with the positively-charged chemical ligands, as shown in FIG. 2, resulting in displacement of the quenching molecule and allowing the emission of the quantum dots to become visible upon excitation. The degree of quencher displacement directly controls how much emission is seen from the quantum dots. This allows for formation of fluorescence patterns on the microplates. The distinctive statistical “fingerprint” output from these arrays can then be further analyzed using SVD analysis to provide which biomolecule of interest exists in the sample. Various ligands are employed, and those which give adequate signal upon displacement of the quencher are modified in terms of the identity of the functional groups attached to the quaternary ammonium nitrogen atom so that the biomolecules used have a variety of electrostatic, hydrophobic, and hydrophilic moieties upon which to interact.

### Example 1

### Quantum Dot Synthesis

### (i) CdSe/ZnS Quantum Dot Synthesis

Synthesis of visible CdSe Core Nanocrystals

The mixture of 2 mmol of CdO, 8 mmol of ODPA, and 80 g of ODE in a 250 mL three neck round bottom flask was heated to about 300° C. under nitrogen atmosphere to obtain a clear solution. After the solution was cooled to room temperature, HDA (15 g) and TOPO (5 g) were added and the solution was reheated to 310° C. At this temperature, a selenium solution in TBP (0.1 M, 20 mL) was quickly injected. The reaction mixture was forced to cool to room temperature quickly and the nanocrystals were purified and exposed to UV light source for conformation (see Figure on quantum dots).

### Synthesis of visible CdSe/ZnS core/shell nanocrystals

The hexane solution of CdSe nanocrystals (1.0 μamp were mixed with 50 g of ODE and 5 g of HAD in a three-neck round bottom flask. Hexane was evaporated out under vacuum and then the mixture was heated to 140° C. under nitrogen atmosphere, and zinc precursor solution (0.1 M diethyl zinc in TBP) was added in dropwise. After stirring for 10 minutes, sulfur precursor solution (0.1 M (TMS)₂S in TBP) was added in dropwise. The reaction mixture was allowed to cool to room temperature, and purified by precipitation and redispersion.

### Synthesis of Water Soluble CdSe/ZnS Quantum Dots

Method 1. Ligand Exchange with DHLA (Dihydrolipoic Acid)

DHLA was prepared by adding 6 g of thiotic acid to 117 ml of the sodium bicarbonate solution (0.25 M) mounted in a cold bath (˜0-5° C.). Then a total of 1.2 g of sodium borohydride (in aliquots of 10-20 mg) was added. The mixture was stirred for ˜30 min until obtaining clear resulting solution. Then ˜100 ml of toluene was added and the mixture was acidified to ˜pH 1. The reduced thiotic acid will transfer fully into the organic phase. The organic phase was separated by separatory funnel and the collected organic layer was dried under magnesium sulfate. The whitish milky solution became clear. The solution was filtered then the solvent was removed under vacuum to produce pure DHLA.

The CdSe/ZnS nanocrystals were transferred to water by dispersing 100 mg of purified original hydrophobic QDs in 5 ml of toluene and 0.3 ml of freshly prepared DHLA with vigorous stirring. The mixture was heated to 60° C. for two hours. The reaction mixture was diluted by 3-5 ml of methanol. The mixture was centrifuged and the supernatant was decanted. The resulting precipitate was dispersed in 0.1 N sodium hydroxide (5 ml). This allows deprotonation of the terminal carboxyl groups on the DHLA. The water soluble QDs were purified by washing with deionized water with centrifuge filter at least four times. Finally, the purified QDs were dispersed in deionized water.

DHLA has two thiol groups on one end and carboxylic acid on the other. Two thiol binding groups improve binding strength of this ligand on the surface of QDs and carboxylic acid group provides water solubility and future functionalization sites. An advantage is that DHLA ligand exchange method is relatively simple and provides very thin organic layer. However, this results in nanocrystals that are not stable at neutral and acidic condition and only stable at slightly basic conditions. Further, due to the quenching effect of thiol group, quantum yields of resulting water-soluble QDs decreases dramatically from that of original QDs.

Method 2. Coating with Amphiphilic Copolymer

An amphiphilic copolymer was prepared by reacting poly(maleic anhydride-alt-1-octadecene) (PMAO, Mn=30,000-50,000) with polyethylene glycol monomethyl ether (mPEG-OH, Mn=2,000) with ratio of 1 to 30 in chloroform and refluxed overnight. The solution was neutralized by 1.0 M sodium hydroxide and then centrifuged to remove the salt.

### Preparation of Water Soluble QDs

The purified CdSe/ZnS nanocrystals were dispersed in chloroform and the amphiphilic copolymer (PMAO-PEG) in chloroform were mixed together and stirred overnight at room temperature (molar ratio of QD/PMAO-PEG is 1:10) (You, 2007). Pure water was then added to the chloroform solution with a 1/1 volume ratio and chloroform was gradually removed by rotary evaporation at room temperature which resulted in a clear solution of water-soluble QDs. In order to remove any possible large contaminants, the solution was passed through a syringe filter and an ultracentrifuge was used to further concentrate and purify (remove excess amphiphilic polymer) the materials. The resulting water-soluble QDs have PEG units and carboxylic acid moieties for further functionalization (Yu, 2007).

### (ii) CdTe Quantum Dot Synthesis

To synthesize CdTe core nanocrystals, a mixture of CdO (0.4 mmol), ODPA (0.88 mmol), and ODE 15 mL was heated in a three-neck flask (100 mL) to 310° C. to obtain a clear solution under nitrogen flow. At this temperature, the Te injection solution (0.1M in TBP diluted with 8 mL of ODE) was quickly injected into hot solution. The reaction mixture was allowed to cool to 240° C. for the growth of CdTe nanocrystals.

As synthesized, CdTe was purified by an extraction method between hexane and methanol (1:1 mixture). The hexane layer was separated and the CdTe nanocrystals were precipitated by addition of acetone. Purified CdTe nanocrystal was redissolved in Chloroform (0.02 mM, 20 mL) and excess amount of DHLA in Chloroform (0.4 mmol) was added. The mixture was stirred for overnight and precipitate was separated by centrifugation. 5 mL of Chloroform and 20 mL of DI water (pH˜10) were added to the precipitate and stirred for several hours. Aqueous layer was separated and filtered through syringe filter (0.45 micron). Clear aqueous solution of CdTe was washed with DI water and redissolved in 1×PBS (phosphate buffer solution) buffer for future use. Thus far, using this scheme, our chemists have generated 580, 610, and 640 nm CdTe quantum dots.

### Example 2

### Conjugation of a Library of Chemical Ligands to Water-Soluble Quantum Dots

Using standard EDAC peptide coupling (FIG. 3), ligands can be conjugated to the surface of the DHLA/polymer shell. These methods have the added benefit of minimal interaction with the actual QD surface.

Conditions for the conjugation reactions must be optimized to produce quantum dots with the appropriate number of ligands per dot as determined through binding assays and FRET experiments. The number of ligands per dot can be determined quantitatively by Rutherford Backscattering Spectroscopy (RBS) or qualitatively by fluorescamine chemistry (which interacts with any free ligand via its amine after conjugation to QD). These techniques have been established as a reliable method to count ligands on the quantum dot surface (Taylor, 2001, Bentzen, 2005).

Ligand conjugation only requires one step (FIG. 3) which is a 2 hour coupling reaction between an amine terminated quaternary amine polyether ligand and a carboxylated QD in the presence of 1-ethyl-3-(3-dimethylaminopropyl)carbodiimide hydrochloride (EDAC, Invitrogen Corp.).

Samples for RBS are prepared by placing a drop of dilute functionalized quantum dots on pyrolytic graphite. The spectra are analyzed to achieve a density of iodine atoms which is correlated to the number of quantum dots (determined by absorption spectroscopy) to generate a number of attachment points per dot. As a control, washings of the sample are analyzed to confirm that no free iodine remains in solution. This is repeated for samples post coupling of the active ligands to determine the coupling efficiency. For fluorescamine chemistry, 40 mL of unpurified aqueous sample is mixed with 10 mL of 6 mg/mL acetone and reacted for 10 min. The resultant fluorescent product (excitation 390 nm/emission 485 nm) from reaction between fluorescamine and any free ligand not conjugated to quantum dot can be monitored via a fluorimeter.

The number and coupling efficiency of chemical ligands per quantum dot is determined, and the maximum amount of ligands are attached as required for efficient (i) quenching of the dot, i.e., through interaction with appropriate number of quenchers, and (ii) interaction with biomolecules. After effectively characterizing the quantum dot-conjugates, they are tested for binding to the quencher and displacement by the biological analytes.

### Example 3

### Optimization of FRET and Determination of Binding Affinity of the Quencher to the Quantum Dot-Ligand Conjugates

FRET is an energy exchange mediated through the dipole-dipole interaction of donor and acceptor species when there is sufficient overlap between the donor emission spectrum and the acceptor absorption spectrum. Due to its high sensitivity to nano-scale changes in distance, FRET provides a unique advantage for monitoring ligand interactions. Quantum dot quenching by FRET is an extremely sensitive detection technique.

Optimization includes determining the optimum ratio of quencher to quantum dot that is required for efficient quenching of the dot, i.e., to turn the dot on to off. It further requires measurement of the binding constant of the quencher to the individual chemical ligands. The former allows optimization of how many ligand/quencher per dot are needed, while the latter provides information on how stable the interaction is between the ligand and quencher. For example, binding constants can be expected to vary between the chemical ligand and the quencher based upon the varying R group as shown in You, 2007. By elucidating how the binding constants vary, the effect of the binding constants can be accounted for when the array is exposed to biomolecules and quencher is displaced. For example, if it is known that the binding constant is strong between a particular ligand and the quencher and a strong signal is observed from that ligand on the array when exposed to a biomolecule, then it can be immediately deduced that the interaction between that ligand and the surface of the biomolecule being tested must be strong.

A method similar to You et al. is used (You et al., 2007). Briefly, a solution containing a known concentration of quantum dot-ligand is excited at 400 nm and the fluorescent emission is monitored using a Fluorolog fluorimeter or BioTek microtier plate reader (see a general representation of CdTe dot fluorescent emission in FIG. 7 prior to adding AuNP—SO₃ quencher). Next, various concentrations of the negatively-charged AuNP—SO₃ quencher in until emission of the quantum dots reaches a minimum level (totally quenched, in the representative case shown in FIG. 7, we elucidated that CdTe was quenched at mole ratio of 2.5:1 QD:AuNP—SO₃). Advantageously, the AuNP quencher has no inherent fluorescent signal, so we only expect to see the emission of the dot. A neutral AuNP—OCH₃ also is assessed as a control, in order to determine the amount of solution quenching and non-specific interactions (if any) are occurring.

Using this technique, the following can be determined: (i) how many ligand/quenchers are required to completely quench the dot and (ii) if the stability of the ionic interaction between the chemical ligand and the dark quencher are amicable for the array, i.e., quencher binding is not too loose or tight, depending on the chemical characteristic on the ligand. Additionally, other chemical ligands that contain various functionalities at the quaternary ammonium salt group can used to observe and optimize, as necessary, the binding constants between these chemical ligands and the dark quenchers.

Ideally, the ratio of ligand to quencher is expected to be ˜1:1 due to the single net (1⁺) and (1⁻) charges on the quaternary ammonium on the ligand (irrespective of what other charge may be on the functional group attached to the amine) and the quencher, respectively. Thus, if there are ˜100 ligands per dot, this would mean that if an equivalent amount of quencher were added there effectively would be 100 quenchers/dot. However, various CdSe/ZnS (8-10 nm), CdTe (5-6 nm), and commercial Invitrogen dots (13-15 nm) which vary greatly in size have been measured, and it has been observed that the greater the size, the more AuNP is required to quench the dot. For example, the CdTe dot only requires ˜a 2.5:1 mole ratio of QD to AuNP—SO₃ to be quenched while the much larger commercial dot requires ˜1:50 mole ratio of QD to AuNP—SO₃ for efficient quenching (the AuNP—SO₃ nanoparticle is estimated to be between 3-5 nm in diameter).

### Example 4

### Generation of Reproducible Fluorescence Patterns from the Interactions of the Solution-Based Biosensor Components with Specific Proteins, Bacterial (Non-Spore) Suspensions, and Spores

Reproducible, distinct fluorescence responses for each biomolecule tested are produced (see FIG. 6). As an initial step, array data from commercial and CdTe dots that were conjugated to AuNP—SO₃ was collected and then exposed to various proteins that differ in size and charge (pI) (See FIG. 6A). The proteins that were tested, listed in increasing size, are cytochrome C (cytC), bovine serum albumin (BSA), lipase, and fibrinogen. There exists already published data for this set of proteins (You et al., 2007), which allows for a good comparison to existing technology. The array also was tested against Gram (−) and Gram (+) bacteria (E. coli and B. subtilis) and a mammalian cell line (murine cardiac cells). See FIG. 6B. The effects of different ligand loading on the same CdSe/ZnS dot in response to a small (cytC) and large (fibrinogen) protein, both alone and mixed, also was assessed (FIG. 6C).

Trimethyl, triethyl, and cyclohexyl quaternary amine commercial and in house CdTe QDs/AuNP SO₃ conjugates were exposed for 10 minutes to 5 mM bovine serum albumin (BSA), cytochrome C, lipase, and fibrinogen (which span small to large proteins). After exposure, the quantitative fluorescence recovery of the dots in the samples was analyzed using a BioTek microtiter plate reader and graphed (see FIG. 6A). As depicted, the proteins induce unique responses from the dots based upon how their surfaces interact and competitively displace the quencher from the quaternary amine ligand. Also, it appears that the CdTe dot provides better differentiation as the responses appear more different from one another (compare commercial and CdTe in FIG. 6A).

In experiments with cells, trimethyl, triethyl, and cyclohexyl quaternary amine commercial and in house CdTe QDs/AuNP SO₃ conjugates were exposed for 10 minutes to E. coli, Bacillus, and murine cardiac cells. After exposure, the quantitative fluorescence recovery of the dots in the samples was analyzed using a BioTek microtiter plate reader and the results are shown in FIG. 6B. As depicted, the cellular surface induces unique responses from the dots based upon how their surfaces interact and competitively displace the quencher from the quaternary amine ligand. Also, it appears that the CdTe dot provides better differentiation as the responses appear more different from one another (compare commercial and CdTe in FIG. 6B).

Testing has been conducted to determine the effect of varying the ligand “loading” on the surface of the same dot, from 20-60%. The difference in effect on both a small and large protein (cytochrome C and fibrinogen) alone and when mixed was studied. Although intuitively it would seem that as more ligand is loaded, there would be an increase in the total response of the system, the results did not bear this out. As seen in FIG. 6C, new responses were instead recorded (compare responses in left and right panels of FIG. 6C) which provides a path forward for collecting even more information on a biomolecule surface by using a singe ligand which is ideal for SVD analysis. Both mixes at 20 and 60% produce results which appear to be mixtures of the two individual protein signals.

The contents of all documents mentioned herein are incorporated in their entirety by reference.

### LITERATURE

1. Altman L K. Experts see need to control antibiotics and hospital infections. New York Times, 1998, Mar. 12.
2. Baldini, L, Wilson, A J, Hong, J, and Hamilton, A D. J. Am. Chem. Soc., 2004, 126:5658.
3. Bowers, M J II, McBride, J R, and Rosenthal, S J. J. Am. Chem. Soc., 2005, 127:15378.
4. Brereton, R. G. in Chemometrics: Data Analysis for the Laboratory and Chemical Plant, John Wiley and Sons, Ltd. 2003.
5. Campbell, C N, deLumley-Woodyear, T., and Heller, A. Fresenius J. Anal. Chem., 1993, 364:165.
6. De, et al. Nature Chemistry, 2009, 1:461.
7. Doxas, I, Nieter, C, Radford, D, Langegren, K, and Cary, J R. Nuclear Instruments and Methods A, 2007, 580:1331.
8. Epstein, J P, and Walt, D R. Chem. Soc. Rev., 2003, 32:203.
9. Fernandez-Arguelles, M T, et al. Nano. Lett., 2007, 7:2613.
10. Förster, T. Energiewanderung and Fluoreszenz. Naturwissenschaften 1946, 6:166. [Title translation: Energy transfer and fluorescence.]
11. Gill, R, Willner I., Shweky, I., and Banin, U. J. Phys. Chem. 8, 2005, 109:23715.
12. Goldman, E R, et. al. J. Am. Chem. Soc., 2005, 127:6744.
13. Jurs, P. C., Bakken, G. A., and McClelland, H. E., 2000, Chem. Rev., 100, 2649-2678.
14. Laukis, L R. Acc. Chem. Res., 1998, 31:317.
15. McCauley, TG, Hamaguchi, N, and Stanton, M. Anal. Biochem., 2003, 319:244.
16. McCleskey, S M, Griffin, M J, Schneider, S E, McDevitt, J T, and Anslyn, E V. J. Am. Chem. Soc., 2003, 125:1114.
17. Medintz, I L, Clapp, A R, Brunel, F M, et. al. Nat. Mater., 2006, 5:581.
18. Medintz, I L, Clapp, A R, Mattoussi, H, Golman, E R, and Mauro, J M. Nat. Mater., 2003, 2:630.
19. Medintz, I L, Clapp, A R, Melinger, J S, Deschamps, J R, and Mattoussi, H. Adv. Mater., 2005, 19:2450.
20. Murray, C B, Kagan, C R, and Bawendi, M G. Annu. Rev. Mater. Sci., 2000, 30:545.
21. Murray, C D.; Norris, D J, and Bawendi, M G. J. Am. Chem. Soc., 1993, 115:8706.
22. Nirmal, M, and Brus L E. Acc. Chem. Res., 1999, 32:407.
23. Pathak, S S and Savelkoul, H F J. Immunol. Today, 1997, 18:464.
24. Pellegrino, T, Manna, L, et. al. Nano. Lett., 2004, 4:703.
25. Phillips, et al. Angew. Chem. Int. Ed. 2008, 47 :2590.
26. Piehler, J., et al. Anal. Biochem., 1997 249:94.
27. Polster, J., Prestel G., Wollenweber, M., Kraus, G., and Gauglitz, G. Talanta, 1995, 42:2065.
28. Reddy, M M, and Kodadek, T. Proc. Natl. Acad. Sci., 2005, 102:12672
29. Riberio, J F, et. al. J. Clin. Microbiol., 1999, 37:1619.
30. Rosenthal, S J et. al. J. Am. Chem. Soc., 2002, 124:4586.
31. Rowe, et al. Anal. Chem., 1999, 71:3846.
32. Sawata, S., Kai E., Ikebukuro, K., Iida, T., Honda, T., and Karube, I. Biosens. Bioelectron., 1999, 14:397.
33. Taylor, J., et al. J. Cluster Science, 2001, 12:571.
34. Toko, K. Biosens. Bioelectron., 1998a, 13:701
35. Toko, K. Meas. Sci. Technol., 1998b, 9:1919
36. You, C. C., et. al. J. Am. Chem. Soc. 2005, 127, 12873-12881
37. You, C. C., et. al. Nat. Nanotechnol., 2007, 2:318.
38. Vo-Dinh, T. and Cullum, B. Fresenius J. Anal. Chem., 2000, 366:540.
39. Vo-Dinh, T, Griffin D, Stokes D, Wintenberg A. Sens. Actuators B, 2003, 90:104.
40. Walt, D R. Acc Chem Res, 1998, 31:267
41. Warnement M, Tomlinson I, and Rosenthal S. Current Nanoscience, 2007, 3:273.
42. Wigelsworth, D J, Krantz, B A, Christensen, K A, Lacy, D B, Juris, S J, and Collier, R J. J. Biol. Chem., 2004, 279:23349.
43. Wright, A T, Griffin, M J, Zhong, Z, McCleskey, S M, Anslyn, E V, McDevitt, JT. Angew. Chem. Int. Ed, 2005a, 44:6375
44. Wright, A T, Anslyn, E V, and McDevitt, J T. J. Am. Chem. Soc, 2005b, 127:17405
45. Zhang, T, Ge, J, Hu, Y, and Yin, Y. Nano. Lett., 2007, 7:3203.
46. Zhou, H, Baldini, L, Hong, J, Wilson, A J, and Hamilton, A D. J. Am. Chem. Soc., 2006, 128:2421.

What is claimed is:

1. A quantum dot biomolecule sensor array, comprising an array of quantum dots, each dot in the array being conjugated with a different chemical ligand, wherein the different chemical ligands vary structurally with respect to a single substituent.

2. An array as claimed in claim 1, wherein the ligands are covalently attached to the quantum dot and comprise a hydrocarbon chain with a functional group at the end which is not attached to the quantum dot.

3. An array as claimed in claim 2, wherein the functional group is a charged group.

4. An array as claimed in claim 3, wherein the group is negatively charged.

5. An array as claimed in claim 3, wherein the group is positively charged.

6. An array as claimed in claim 5, wherein the group is an ammonium group.

7. An array as claimed in claim 6, wherein the ligands in the array differ only with respect to the substituents on the quaternary ammonium group.

8. An array as claimed in claim 2, additionally comprising a quencher which interacts with the functional group, wherein the quencher has a broad absorption spectra which overlays with the emission of the quantum dot, so that FRET occurs between the dot and the quencher.

9. A combination, comprising:
a quantum dot biomolecule sensor array comprising an array of quantum dots, each dot in the array being conjugated with a different chemical ligand, wherein the different chemical ligands vary structurally with respect to a single substituent, wherein the ligands are covalently attached to the quantum dot and comprise a hydrocarbon chain with a functional group at the end which is not attached to the quantum dot, the array further comprising a quencher which interacts with the functional group, wherein the quencher has a broad absorption spectra which overlays with the emission of the quantum dot, so that FRET occurs between the dot and the quencher, and
FRET monitoring means for measuring fluorescence emitted by quantum dots in the array.

10. A combination according to claim 9, additionally comprising means for comparing the pattern of fluorescence emitted by the array with a library of fluorescence patterns for known molecules.

11. A method of differentiating biological molecules within a sample, comprising:
providing a quantum dot biomolecule sensor array comprising an array of quantum dots, each dot in the array being conjugated with a different chemical ligand, wherein the different chemical ligands vary structurally with respect to a single substituent, wherein the ligands are covalently attached to the quantum dot and comprise a hydrocarbon chain with a functional group at the end which is not attached to the quantum dot, the array further comprising a quencher which interacts with the functional group, wherein the quencher has a broad absorption spectra which overlays with the emission of the quantum dot, so that FRET occurs between the dot and the quencher,
contacting the array with a sample of interest, and
monitoring fluorescence from the array using FRET.

12. The method according to claim 11, additionally comprising comparing the fluorescence pattern of the array to a library of known fluorescence patterns associated with known molecules to identify molecules contained in the sample.
